(19) United States
(12) Patent Application Publication
(10) Pub. No.: US 2007/0156641 A1
(43) Pub. Date: Jul. 5, 2007

(54) System and method to provide system independent configuration references

(76) Inventors: Thomas Mueller, Oberkirch (DE); Ingo Zenz, Epfenbach (DE)

Correspondence Address: SAP/BLAKELY, 12400 WILSHIRE BOULEVARD, SEVENTH FLOOR, LOS ANGELES, CA, 90025-1030, US

(21) Appl. No.: 11/322,701

(22) Filed: Dec. 30, 2005

(51) Int. Cl. G06F 17/30

(52) U.S. Cl. 707/2

(57) ABSTRACT

A system and method to reduce configuration redundancy using system independent configuration references. A persistent storage unit returns system independent configuration entries. Some of the entries contain reference to other entries. A configuration resolver resolves the references to obtain a static value for the configuration entry that may be passed to a configuration consumer.

### BACKGROUND OF THE INVENTION

1. Field

The invention relates to virtual system configuration. More specifically, the invention relates to abstracting configuration data to reduce administration.

2. Background

With various enterprise software solutions improved scalability and reduced administration have been the goal. One countervailing force to this goal is the distribution of configuration data within the system. Existing systems redundantly store static values for system dependent information distributed across a cluster configuration tree. These system dependent settings are statically determined within the configuration database. This requires manual intervention responsive to system change. For example, with system copy, the requirement of manual adaptation makes it impossible to use a configuration as it is from one system to another. Even minor changes, such as a change in Java Home, System Name, Instance Number, Host Name, etc., requires manual adjustment. Moreover, changes in configuration data often necessitate onsite visits by software technicians to provide the correct configuration data for an appropriate system operation. This drives up the cost of changing, scaling or even maintaining a system.

### SUMMARY OF THE INVENTION

A system and method to reduce configuration redundancy using system independent configuration references is disclosed. A persistent storage unit returns system independent configuration entries. Some of the entries contain reference to other entries. A configuration resolver resolves the references to obtain a static value for the configuration entry that may be passed to a configuration consumer.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of the system of one embodiment of the invention.

FIG. 2 is a flow diagram of one embodiment of the invention.

FIG. 2A is a flow diagram of resolution of a reference link in one embodiment to the invention.

FIG. 3 is a diagram of a partial configuration tree of one embodiment of the invention.

### DETAILED DESCRIPTION

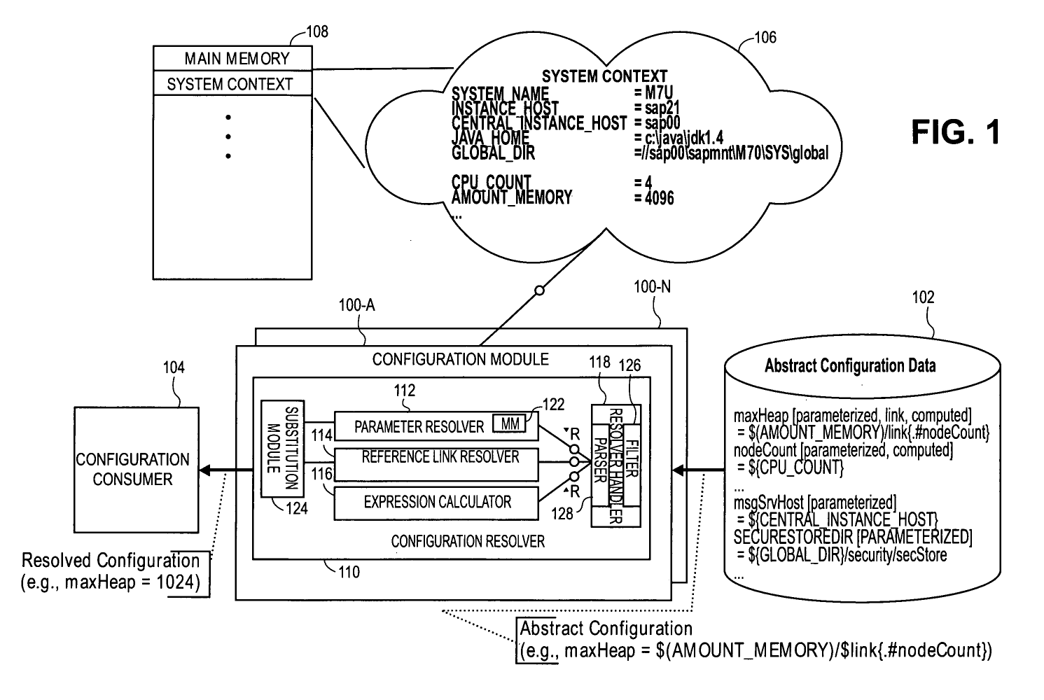

FIG. 1 is a block diagram of the system of one embodiment of the invention. The configuration module 100 includes a configuration resolver 110. Configuration resolver 110 is used to resolve abstract configuration data, which is stored persistently in the database 102. By resolving, it is meant that the abstract expression having a known semantic is converted to a static value to pass to a configuration consumer 104. In various embodiments, configuration consumer 104 may be a manager, a service or an application. Typically, in a cluster environment, each server node will have a configuration module 100, 100-N, but only a single configuration database 102 will be shared amongst the nodes in the cluster. In some embodiments, the cluster is homogenous, such that the same configuration is applied to all of the nodes in the cluster. In such case, the abstract configuration described below is of a particular benefit in reducing redundancy. At system start-up, configuration module 100 creates system context 106, which is stored in main memory 108. The system context 108 associates identifiers with static values that may be a function of the underlying hardware. Different system contexts can be attached to the same configuration data as a result of, for example, system copy. Because the configuration data is abstracted away from underlying system dependencies and only resolved to a static value at run time, reuse is simplified. In one embodiment, the system context is created using instance profiles for instances of the system. In one embodiment, the system context contains system dependencies such as, host names, operating system (O/S) information, installation directories, etc. The system context may also contain hardware dependencies such as, number of CPU, amount of physical memory, etc.

In one embodiment, configuration resolver includes a resolver handler 118, which filters incoming configuration data from database 102 using a filter 126 to identify if the configuration should be passed to a parser 128 within the resolver handler. Parser 128 identifies the semantic of various abstract configuration components and calls an appropriate resolver within the configuration resolver 110 to resolve those components.

For example, in one embodiment, configuration resolver 110 includes a parameter resolver 112, a reference link resolver 114 and an expression calculator 116. In one embodiment, parameters are semantically reflected as ${identifier}. When the parser finds that semantic within a configuration entry, the call is made to the parameter resolver 112 to obtain a static value for that parameter. To obtain a static value for the parameter, parameter resolver 112 uses a matching module 122 to match the identifier against an identical identifier in the system context 108 and retrieve the corresponding static value from the system context 108. The static value is then substituted for the parameter in the configuration entry. The static value may then be returned to the resolver handler 110 or if a particular configuration data is fully resolved by virtue of the resolution of the parameter, the resulting static value may be passed to configuration consumer 104.

If the parser 128 finds a reference link abstraction within the configuration entry, a call is made to reference link resolver 114. In one embodiment, the semantic for a reference link is $link {pathname}. Reference link resolver 114 follows the path and substitutes the value obtained at the end of the path using substitution module 124 to provide a static value or possibly substitute a parameter as explained below. The path can be either absolute or relative. Relative paths facilitate inheritance. For example, a configuration B is derived from configuration A. A contains a config entry a=‘a’ and a reference link alink=‘.#a’ Configuration B overwrites value “a” to a=‘b’. Therefore, value alink in configuration A will be resolved to ‘a’, but the inherited value alink in configuration B it will be resolved to ‘b’. In one embodiment, the path generally points to another configuration entry in the configuration tree, which may itself be an abstract configuration entry requiring further resolution. Thus, for example, $link{#nodeCount} points to the configuration entry node count, which is equal to ${cpu_count}. In this case, node count will finally resolve to 4, but maxHeap is discerned by first calling the parameter resolver 112 to obtain the Amount Memory which is 4,096. Then resolver manager 118 calls the reference resolver link 114 to follow the link to nodeCount, which returns the parameterized value CPU_COUNT. The resolver manager 118 again calls the parameter resolver 112 to which resolver context CPU_COUNT to 4 with reference to the system. Then the two static values for AMOUNT_MEMORY (4096) and CPU_COUNT (4) are passed with the call to expression calculator 116 to conduct the division.

Expression calculator 116, in one embodiment, performs simple arithmetic functions such as, add, subtract, multiply, divide, min, max, round and truncate. More or fewer arithmetic operations may be supported. In the above example, when the static value of maxHeap is finally calculated by the expression calculator 116, it may be passed to configuration consumer 104. Thus, in one embodiment, resolver handler 118 calls the individual resolvers 112, 114 and 116 sequentially as needed to resolve abstract configuration data into a static value that may be passed to a configuration consumer 104 at run time. It should be noted that the resolver handler 118 need not call every resolver and calls in parallel or a different order than the example above may occur.

In one embodiment, when the system starts up, a system context is created. In one embodiment, the system context is stored in main memory. This activity is all part of the initialization process and is decoupled from the subsequent steady state operation of the system.

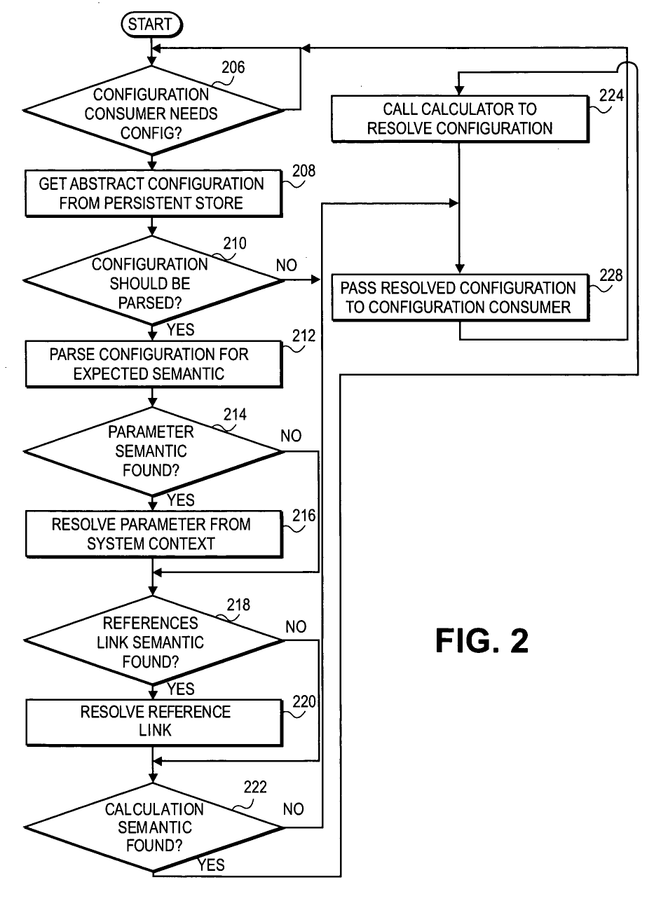

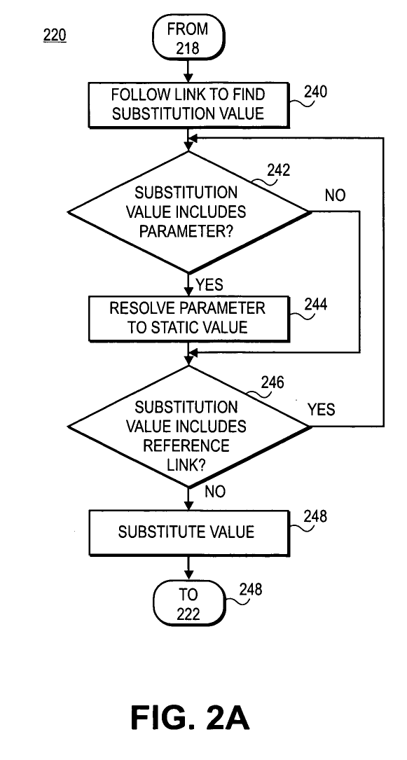

FIG. 2 is a flow diagram of one embodiment of the invention. At block 206, a decision is made whether a configuration consumer needs configuration data. If not, the system waits at 206 until configuration data is needed.

At block 208, abstract configuration data is retrieved from a persistent store. In one embodiment, the persistent store is a database. At decision block 210, the determination is made whether the configuration data obtained from the persistent store should be parsed. For example, it is possible that configuration data may have a form that is analogous to the semantic that would require parsing, but should otherwise not be parsed because it is already the value that should be passed as the static configuration value to the configuration consumer. In such case, the filter bypasses the parser and forwards the configuration data to the configuration consumer without parsing.

If the configuration data should be parsed, at block 212 the configuration is parsed to identify the expected semantic. While one possible semantic for parameters and reference links is set forth above, any suitable semantic identifiable by the parser may be used. At block 214, a determination is made whether a parameter semantic is found. If so, the parameter is resolved with reference to the system context at block 216. At block 218, a determination is made if a reference link semantic is found. If so, at block 220, the reference link is resolved. Resolution of the reference link is described in further detail with reference to FIG. 2A below. At block 222, a determination is made if the calculation semantic is found. In which case, at block 224 an expression calculator is called to resolve the configuration entry. The static value is passed to the configuration consumer at block 228. In one embodiment, a call to e.g., resolve references or resolve parameters resolves all references or parameters in the configuration entry at once. In one alternative embodiment, the resolver may be called iteratively until the configuration is fully resolved. It should be recognized that a configuration entry may include more than one reference link and/or parameter.

FIG. 2A is a flow diagram of resolution of a reference link in one embodiment to the invention. At block 240, the link is followed to find a value to be substituted in the configuration entry. This value may be a static value, a parameterized value, another value link or an arithmetic expression. At decision block 242, a determination is made if the substitution value contains a parameter. If so, at block 244, the parameter is resolved to a static value. After parameter resolution or if no parameter is present, at block 246, a determination is made whether the substitution value includes a reference link. If a reference link is present, it recursively follows the flow continuing at block 240. If no reference link is present, the substitution value (w/any parameters resolved) is substituted in the configuration entry for the original reference link. In this manner, any depth of linking may be accommodated.

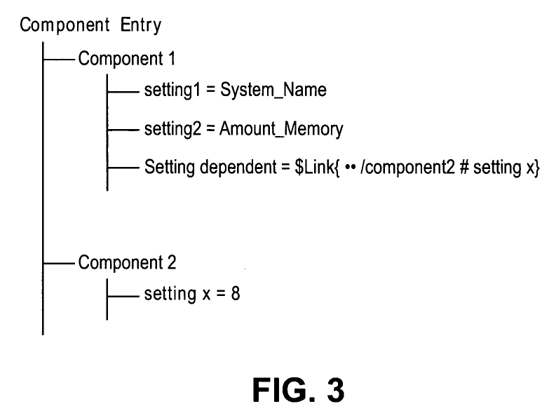

FIG. 3 is a partial configuration tree of one embodiment of the invention. FIG. 3 shows a reference link in component, to configuration value component₂. This illustrates how one of reference links can reduce the redundancy of system specific values within the configuration tree. While in this example, the value of the linked setting is short, in some cases longer values may result in memory saving by using the links. In any case, the administration of e.g., this single static value is less than if the static value were redundantly distributed throughout the configuration tree.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments of the present invention may also be provided as a machine-readable medium for storing the machine-executable instructions. The machine-readable medium may include, but is not limited to, flash memory, optical disks, compact disks read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A system comprising:
a persistent storage unit to persistently retain a plurality of system independent configuration entries, at least some of the plurality containing references to other configuration entries;
a configuration resolver to resolve the references to obtain a system dependent static configuration value; and
a configuration consumer to receive the system dependent static configuration value without knowledge of the reference.

2. The system of claim 1 wherein the configuration resolver comprises:
a parser to identify the reference within a configuration entry; and
a substitution module to substitute a referenced configuration entry for the reference.

3. The system of claim 1 wherein the configuration consumer comprises one of:
an application;
a manager; and
a service.

4. The system of claim 1 wherein the persistent storage unit comprises:
a database.

5. A machine-accessible medium containing instructions that when executed cause a machine to:
obtain an first configuration entry containing a reference to a second configuration entry at least the first configuration entry independent of a physical system; and
resolve the reference to obtain a static value for the first configuration entry, the static value corresponding to the physical system.

6. The machine accessible median of claim 5, wherein the instructions causing the machine to resolve cause the machine to:
parse the first configuration entry to identify the reference; and
follow the reference to the second configuration entry.

7. The machine accessible median of claim 6, wherein the instructions causing the machine to resolve further cause the machine to:
resolve the second configuration entry to obtain the static value.

8. The machine accessible median of claim 5, wherein the instructions causing the machine to resolve cause the machine to:
refer to a system context created at system startup.

9. The machine accessible median of claim 5, including further instructions causing the machine to:
pass a static resolved configuration entry to a configuration consumer.

10. A method comprising:
obtaining an first configuration entry containing a reference to a second configuration entry at least the first configuration entry independent of a physical system; and
resolving the reference to obtain a static value for the first configuration entry, the static value corresponding to the physical system.

11. The method of claim 10 wherein resolving comprises:
parsing the first configuration entry to identify the reference; and
following the reference to the second configuration entry.

12. The method of claim 11 wherein resolving further comprises:
resolving the second configuration entry to obtain the static value.

13. The method of claim 12 wherein resolving second configuration entry comprises:
referring to a system context created at system startup.

14. The method of claim 12, wherein resolving the second configuration entry comprises one of:
following a reference link; and
resolving a parameter.

15. The method of claim 10 further comprising:
passing a static resolved configuration entry to a configuration consumer.

16. The method of claim 11 wherein the reference provides one of an absolute path to the second configuration entry or a relative path to the second configuration entry.
